(19) United States
(12) Patent Application Publication
(10) Pub. No.: US 2006/0071637 A1
(43) Pub. Date: Apr. 6, 2006

(54) Battery pack and its method of manufacture

(76) Inventors: Sang-Do Heo, Youngin-si (KR); In-Han Kim, Youngin-si (KR)

Correspondence Address: Robert E. Bushnell, Suite 300, 1522 K Street, N.W., Washington, DC, 20005-1202, US

(21) Appl. No.: 11/232,432

(22) Filed: Sep. 22, 2005

(30) Foreign Application Priority Data
Sep. 22, 2004 (KR) 2004-0076143

(51) Int. Cl. H02J 7/00

(52) U.S. Cl. 320/113

(57) ABSTRACT

A battery pack having no need to fill a gap between a bare cell and a protective circuit module includes a safety vent adapted to properly function even after molding has been completed and a PTC thermistor having characteristics which do not degrade during manufacturing processes. A bare cell, which has a protective circuit module and a PTC thermistor mounted thereon, is enclosed by an integral case. An exposed area of the case is covered with a resin. A lead is positioned on a safety vent formed on the bare cell to prevent the safety vent from being fractured by a resin of a high temperature and pressure during a resin filling process. The resin does not reach the protective circuit module and the PTC thermistor so that its heat is not transmitted to them.

### CLAIM OF PRIORITY

This application makes reference to, incorporates the same herein, and claims all benefits accruing under 35 U.S.C. §119 from an application for BATTERY PACK AND ITS METHOD OF MANUFACTURE earlier filled in the Korean Intellectual Property Office on 22 Sep. 2004 and there duly assigned Serial No. 2004-0076143.

### BACKGROUND OF THE INVENTION

1. Field of the Invention

The present invention relates to a battery pack and its method of manufacture, and more particularly to a battery pack having no need to fill the gap between a bare cell and a protective circuit module and including a safety vent adapted to properly function even after packing has been completed and a PTC thermistor having characteristics which do not degrade during manufacturing processes, and its method of manufacture.

2. Description of the Related Art

In general, a battery pack includes a chargeable/dischargeable bare cell, a protective circuit module electrically coupled to the bare cell to control charging/discharging and interrupt the current in the case of overcharging/over-discharging, a resin filling the gap between the bare cell and the protective circuit module to prevent the protective circuit module from detaching the bare cell, and a case packed with the bare cell, the protective circuit module, and the resin to be mounted on an external set.

A method of manufacturing a battery pack includes the following processes: a lead is connected to the positive electrode of the bare cell and a PTC thermistor is connected to the negative electrode thereof. The protective circuit module is again electrically connected to the lead and the PTC thermistor. The gap between the protective circuit module and the bare cell is filled with a resin to mechanically fix them so that the protective circuit module does not detach from the bare cell. The bare cell, the protective circuit module, and the like are then packed into a case to be mounted on an external set. The case is integrally molded using another resin together with the bare cell, the protective circuit module, and the resin. Alternatively, upper and lower cases are separately provided and, after placing the bare cell and the protective circuit module between them, are attached to each other.

However, such a battery pack has a problem in that molding must be performed using a resin to mechanically fix the protective circuit module and the bare cell. Particularly, a resin of high temperature and pressure must fill the very small gap between the bare cell and the protective circuit module. Then, various electronic components on the protective circuit module are easily damaged and the lead and the PTC thermistor, which have previously been connected to each other, can detach from each other.

The PTC thermistor increases its resistance value when the temperature reaches about 70-80° C. and interrupts the current flowing through the circuit. Once it is actuated, its resistance value does not drop to the exact original value or device characteristics degrade, even when the temperature returns to normal range. Since the resin has a temperature of about 150° C. when filling the gap between the bare cell and the protective circuit module, the PTC thermistor is very likely to be actuated and degrade its characteristics.

In order to solve this problem, the PTC thermistor can be arranged on the outer periphery of the bare cell, and not between the bare cell and the protective circuit module. However, the PTC thermistor is then exposed to the danger of hitting other objects and being damaged by them during manufacturing processes. The thickness of the PTC thermistor must also be taken into account when manufacturing the case. This makes the manufacturing processes complicated and increases cost.

In addition, a separate mold is necessary to fill the gap between the protective circuit module and the bare cell with a resin. This further increases the manufacturing cost of the battery pack and, as the processes become more complicated, the defect ratio increases.

The bare cell generally has a safety vent formed on the bottom surface thereof opposite to the protective circuit module, in order to evacuate internal gas to the exterior when the internal pressure rises. The safety vent has a smaller thickness so that it fractures when the internal pressure rises and evacuates the high-pressure gas inside the bare cell to the exterior. When the bare cell is enclosed by a resin to shape a case of a battery pack, however, the resin having a high temperature and pressure can pass through the safety vent and partially penetrate into the bare cell. In this case, the safety vent may fail to function even when the internal pressure of the bare cell rises.

If the safety vent does not function properly, the bare cell is subjected to a very high pressure and eventually explodes or catches fire at a critical pressure. This seriously degrades the reliability of the battery pack.

### SUMMARY OF THE INVENTION

Accordingly, the present invention has been made to solve the above-mentioned problems, and an object of the present invention is to provide a battery pack having no need to fill the gap between a bare cell and a protective circuit module so that its cost decreases and a PTC thermistor does not degrade its characteristics, and its method of manufacture.

Another object of the present invention is to provide a batter pack having a lead positioned on a safety vent formed on a bare cell to prevent resin from contacting or passing through the safety vent so that the safety vent can normally function when the bare cell swells, and its method of manufacture.

Still another object of the present invention is to provide a battery pack having no need to entirely mold a bare cell and a protective circuit module when forming a case to obviate a high temperature being transmitted to a PTC thermistor and degrading its characteristics, and its method of manufacture.

In order to accomplish these objects, a battery pack is provided including: a bare cell; a protective circuit module electrically connected to the bare cell; a case integrally housing the bare cell and the protective circuit module and adapted to expose a predetermined region of the bare cell to the exterior; and a resin adapted to fill a gap between the case and the bare cell and to cover a surface of the exposed predetermined region of the bare cell.

The battery pack preferably further includes a lead electrically connected between the bare cell and the protective circuit module.

The battery pack preferably further includes a PTC thermistor electrically connected between the bare cell and the protective circuit module.

The protective circuit module preferably includes at least one external terminal arranged thereon and the case preferably includes an opening arranged therein, the opening corresponding to the at least one external terminal.

The battery pack preferably further includes an insulating ring arranged between the protective circuit module and the bare cell.

The resin preferably extends to a level corresponding to 50-90% of an overall height of the case along the gap between the bare cell and the case.

The bare cell preferably includes a safety vent, arranged on the exposed predetermined region of the bare cell and having a thickness less than that of the bare cell, and a lead arranged on the safety vent and electrically connected to the protective circuit module.

In order to also accomplish these objects, a battery pack is provided including: a chargeable/dischargeable bare cell having positive and negative electrodes; a protective circuit module arranged on a side of the bare cell; a lead electrically connecting one of the positive and negative electrodes of the bare cell to the protective circuit module; a PTC thermistor electrically connecting the other of the positive and negative electrodes of the bare cell to the protective circuit module; a case integrally housing the bare cell, the protective circuit module, the lead, and the PTC thermistor and adapted to expose a side of the protective circuit module and a side of the bare cell to the exterior; and a resin adapted to cover the exposed side of the bare cell.

The bare cell preferably includes: a can having one of positive and negative polarities; and an electrode terminal arranged on a side of the can and having a polarity different from that of the can.

The can preferably includes: long-sided regions spaced apart from each other; short-sided regions arranged on edges of the long-sided regions and spaced apart from each other; and a bottom-sided region arranged on common edges of the long-sided regions and the short-sided regions.

The can preferably further includes a safety vent arranged in the bottom-sided region and having a thickness less than that of the can. The safety vent preferably includes a lead arranged on a surface thereof.

The lead is preferably welded to one of the bottom-sided region outside of the safety vent or to one of the short-sided regions.

The bottom-sided region of the can is preferably exposed to the exterior of the case and is preferably covered with a resin.

The resin preferably fills a gap between the long-sided and short-sided regions of the can and the case and extends to a level corresponding to 50-90% of an overall height of the case from the bottom side.

The protective circuit module preferably includes at least one external terminal arranged thereon and the case preferably has an opening arranged therein, the opening corresponding to the external terminal.

The battery pack preferably further comprising an insulating ring interposed between the bare cell and the protective circuit module.

The case preferably includes: long-sided regions spaced apart from each other; short-sided regions arranged on edges of the long-sided regions and spaced apart from each other; and an upper-sided region arranged on common edges of the long-sided regions and the short-sided regions and having a number of openings. The case preferably has round portions arranged in the long-sided regions and the short-sided regions.

In order to also accomplish these objects, a method of manufacturing a battery pack is provided, the method comprising: preparing a chargeable/dischargeable bare cell; electrically connecting a lead and a PTC thermistor to the bare cell and electrically connecting the lead and the PTC thermistor to a protective circuit module; enclosing the protective circuit module and the bare cell in a case having an open side; and covering an exposed side of the bare cell with a resin.

The method preferably further includes interposing an electrically insulating ring between the protective circuit module and the bare cell to prevent the protective circuit module from contacting and short-circuiting to the bare cell.

The method preferably further includes arranging a safety vent in the exposed side of the bare cell, the safety vent having a thickness less than that of the bare cell and a lead arranged on the safety vent while being connected to the protective circuit module to prevent resin from contacting the safety vent during a molding process.

The method preferably further includes extending the resin to a level corresponding to 50-90% of an overall height of the case along a gap between the bare cell and the case.

The battery pack and its method of manufacture according to the present invention are advantageous in that, since the bare cell and the protective circuit module are enclosed by an integral case to fix them and a resin is used to fill only a part exposed by the case, the gap between the bare cell and the protective circuit module does not need to be filled with a resin. This reduces cost and prevents the protective circuit module and the PTC thermistor from being damaged.

Since a lead is positioned on the surface of the safety vent formed on the bare cell, the safety vent does not fracture during resin filling. Particularly, a resin of high temperature and pressure does not contact or pass through the safety vent during resin filling process, so that the safety vent is not fractured by it. As a result, the safety vent functions normally in the case of swelling and minimizes the danger of explosion.

Since a resin of high temperature and pressure is injected onto the surface of the bare cell opposite to the protective circuit module, the resin's temperature is not transmitted to the protective circuit module or the PTC thermistor, which is positioned at the opposite end. As a result, the protective circuit module or the PTC thermistor is protected from the resin of high temperature and pressure.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a perspective view of a battery pack according to an embodiment of the present invention;

FIG. 2 is an exploded perspective view of a battery pack according to an embodiment of the present invention;

FIG. 3a is a partial sectional view taken along line 1a-1a of FIG. 1;

FIG. 3b is a sectional view taken along line 1b-1b of FIG. 1;

FIG. 4 is an exploded perspective view of a bare cell of a battery pack according to an embodiment of the present invention; and

FIGS. 5a to 5d are views of a series of steps of a method of manufacturing a battery pack according to an embodiment of the present invention.

### DETAILED DESCRIPTION OF THE INVENTION

Hereinafter, exemplary embodiments of the present invention are described with reference to the accompanying drawings. In the following description and drawings, the same reference numerals are used to designate the same or similar components, and so a repetition of the description of the same or similar components has been omitted.

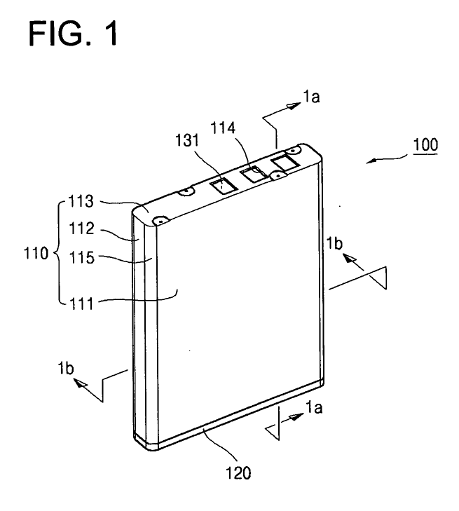

FIG. 1 is a perspective view of a battery pack according to an embodiment of the present invention.

As shown in FIG. 1, the exterior of a battery pack 100 according to an embodiment of the present invention is enclosed by an approximately hexahedral case 110. The case 110 includes long-sided regions 111 spaced apart from each other and short-sided regions 112 positioned on the edges of the long-sided regions 111 while being spaced apart from each other. The area of the short-sided regions 112 is less than that of the long-sided regions 111. The case 110 can further include round portions 115 formed with a predetermined radius at the interface between the long-sided regions 111 and the short-sided regions 112. However, this feature is optional in the present invention. Alternatively, the long-sided regions 111 and the short-sided regions 112 can intersect at an approximately right angle. The case 110 includes an upper-sided region 113 positioned on the common edges of the long-sided regions 111 and the short-sided regions 112 and a number of openings 114 formed in the upper-sided region 113.

The case 110 can be formed using any material chosen from PolyCarbonate (PC), PolyEthylene Terephthalate Glycol (PETG), PolyEthylene (PE), PolyPropylene(PP), and an equivalent thereof. However, the present invention is not limited to these materials and manufacturing methods.

The space beneath the case 110 is filled with a resin 120 to prevent a bare cell (not shown) and the like positioned therein from escaping to the exterior. The resin 120 can be polyamide, nylon, or an equivalent thereof, which has a melting point of about 150° C. However, the present invention is not limited to these materials.

In FIG. 1, reference numeral 131 refers to external terminals of a protective circuit module (described later).

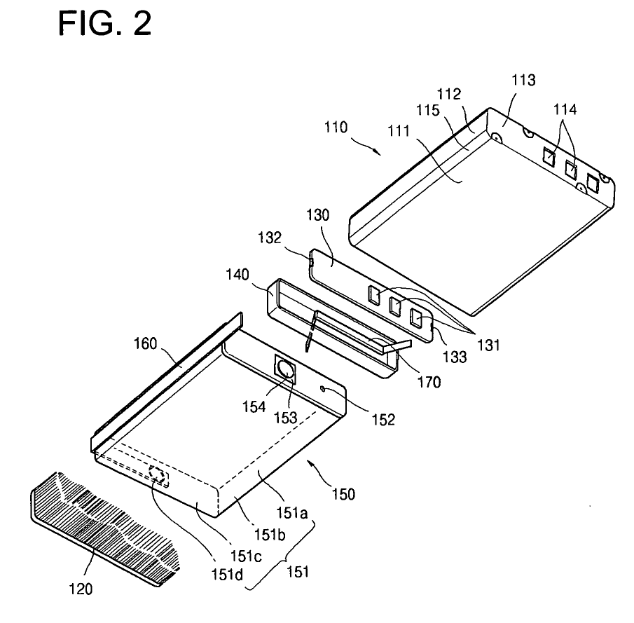

FIG. 2 is an exploded perspective view of a battery pack according to an embodiment of the present invention.

As shown in FIG. 2, the battery pack 100 according to an embodiment of the present invention includes a case 110, a resin 120, a protective circuit module 130, an insulating ring 140, and a bare cell 150. The protective circuit module 130 and the bare cell 150 are respectively connected to a lead 160 and a Positive Temperature Coefficient (PTC) thermistor 170.

The protective circuit module 130 of an approximately square shape, as shown, has a number of external terminals 131 formed on its surface. The external terminals 131 are exposed to the exterior via the openings 114 of the case 110. The protective circuit module 130 has conductive patterns 132 and 133 respectively formed on opposite sides thereof. The lead 160 and the PTC thermistor 170 are respectively soldered or welded to the conductive patterns 132 and 133. The protective circuit module 130 has a number of electronic components (not shown) mounted thereon. The protective circuit module 130 controls the charging/discharging of the bare cell 150 and opens the circuit-when the bare cell 150 is overcharged/over-discharged.

The insulating ring 140 is interposed between the protective circuit module 130 and the bare cell 150. The insulating ring 140 has an approximately rectangular shape in conformity with the surface of the protective circuit module 130 and the bare cell 150. The insulating ring 140 has a predetermined thickness so that various components on the protective circuit module 130 do not directly short-circuit to the surface of the bare cell 150. Instead of the insulating ring 140, insulating paper can be positioned between the protective circuit module 130 and the bare cell 150.

The bare cell 150 is positioned beneath the insulating ring 140. The bare cell 150 is an energy source adapted to be charged with a predetermined amount of energy or discharged. More particularly, the bare cell 150 includes a can 151 having any polarity chosen from positive and negative polarities, a cap plate 152 positioned on top of the can 151, and an electrode terminal 154 positioned at the center of the cap plate 152 while being enclosed by an insulating gasket 153. When the can 151 and the cap plate 152 have a positive polarity, for example, the electrode terminal 154 has a negative polarity, and vice versa. The can 151 includes long-sided regions 151a spaced apart from each other, short-sided regions 151b positioned on the edges of the long-sided regions 151a while being spaced apart from each other, and a bottom-sided region 151c positioned on the common edges of the long-sided regions 151a and the short-sided regions 151b and having a predetermined area. Round portions can be formed at the interface between the long-sided regions 151a and the short-sided regions 151b. However, this feature is optional in the present invention. Alternatively, the long-sided regions 151a and the short-sided regions 151b can intersect at an approximately right angle. The bottom-sided region 151c of the can 151 can have a safety vent 151d formed thereon with a smaller thickness.

The resin 120 covers a part of the bare cell 150 exposed via the case 110, particularly, the bottom-sided region 151c of the can 151 and prevents the bare cell 150 from escaping out of the case 110. The resin 120 reaches a level corresponding to about 50-90% of the overall height of the case 110 to improve adhesiveness to the case 110 or the bare cell 150 and to prevent high temperature (about 150° C.) from being transmitted to the protective circuit module 130 or the PTC thermistor 170 during the resin filling process, which is described later in more detail.

The lead 160 electrically connects the bare cell 150 to the protective circuit module 130. As shown, the lead 160 is bent into an approximately L-shaped configuration. The lead 160 covers the safety vent 151d formed in the bottom-sided region 151c of the can 151. As a result, the resin 120 of high temperature and pressure does not pass through the safety vent 151d and secure its safety during the resin filling process. The lead 160 is welded to a part of the bottom-sided region 151c of the can 151, except for the safety vent 151d, or to any of the short-sided regions 151b. If the lead 160 is welded to the safety vent 151d and completely covers it, the safety vent 151d cannot function properly when the bare cell 150 swells. The lead 160 is soldered or welded to the conductive pattern 132 formed on the protective circuit module 130.

One side of the PTC thermistor 170 is welded to the electrode terminal 154 and the other side thereof is welded or soldered to the conductive pattern 133 of the protective circuit module 130. The PTC thermistor 170 increases its resistance value when the temperature of the bare cell 150 rises above an allowable level and interrupts the current flowing through the circuit. The characteristics of the PTC thermistor 170 remain intact during manufacturing processes, because the temperature (about 150° C.) of the resin 120 is not transmitted thereto. This means that a low resistance value, which has been set initially, remains unchanged and less power is consumed during charging/discharging process of the bare cell 150. As a result, charging/discharging efficiency of the battery pack 100 is maintained at initial design value.

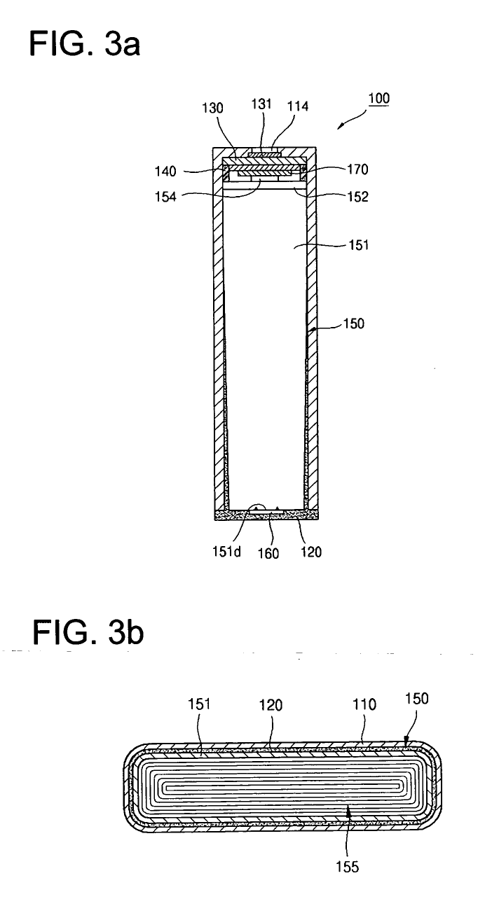

FIG. 3a is a partial sectional view taken along line 1a-1a of FIG. 1 and FIG. 3b is a sectional view taken along line 1b-1b of FIG. 1. As shown in FIGS. 3a and 3b, the external terminals 131 of the protective circuit module 130 are exposed via the openings 114 formed on the case 110. The protective circuit module 130, the insulating ring 140, and the bare cell 150 (i.e., cap plate 152 and can 151) in the remaining regions are protected from the external environment by the case 110. Since the lead 160 is positioned on the safety vent 151d formed on the lower portion of the bare cell 150, the resin 120 does not pass through the safety vent 151d. However, the safety vent 151d and the lead 160 are not welded to each other, as mentioned above, so that the safety vent 151d can function normally when the bare cell 150 swells.

The resin 120 has a predetermined thickness on the lower portion of the case 110 and fills the gap between the bare cell 150, particularly the surface of the can 151, and the case 110 up to a predetermined level. Particularly, the resin 120 reaches a level corresponding to 50-90% of the overall height of the case 110. If the filling level of the resin 120 is less than 50% of the overall height of the case 110, then adhesiveness of the resin 120 to the can 151 and the case 110 is poor. If the filling level of the resin 120 is greater than 90% of the overall height of the case 110, then the high temperature can be transmitted to the overlying PTC thermistor 170 and degrade its characteristics.

In the drawings, reference numeral 155 refers to an electrode assembly mounted inside the bare cell 150.

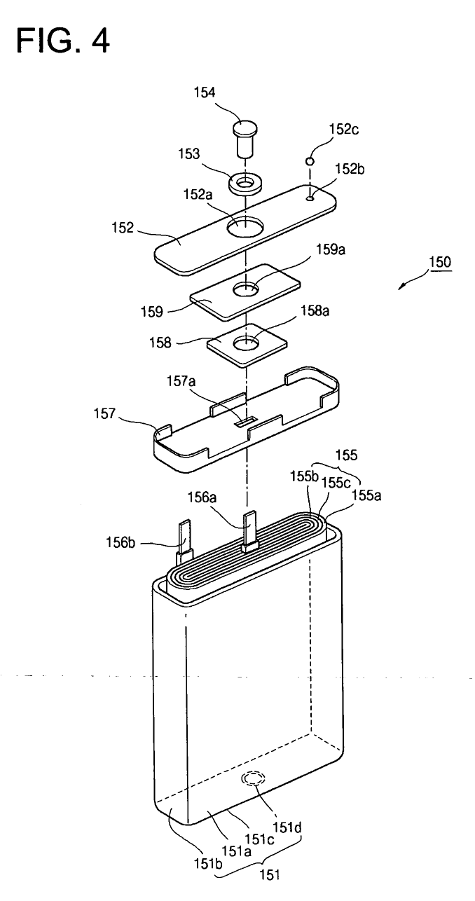

FIG. 4 is an exploded perspective view of a bare cell of a battery pack according to an embodiment of the present invention. In general, a bare cell of a battery pack has no protective circuit module and the like mounted thereon, as shown in FIG. 4. It is to be noted that the bare cell is just given as an example to help the overall understanding of the battery pack according to the present invention and the present invention is not limited to the construction thereof disclosed herein. Specifically, the case and resin of the present invention can be applied not only to the bare cell as shown, but also to other types of bare cells not shown.

As shown, the bare cell 150 can include an electrode assembly 155 adapted to be charged with a predetermined amount of energy or discharged, a can 151 containing the electrode assembly 155, a cap plate 152 attached to the top of the can 151 to prevent the electrode assembly 155 from escaping, and an electrolyte (not shown) injected into the can 151 to enable ions to move inside the electrode assembly 155.

The electrode assembly 155 can include a positive electrode plate 155a having a positive electrode active material (for example: lithium cobalt oxide, LiCoO₂, lithium nickel oxide, LiNiO₂, lithium manganese oxide, LiMn₂O₄, or an equivalent thereof) attached thereto, a negative electrode plate 155b having a negative electrode active material (for example, graphite or an equivalent thereof) attached thereto, and a separator 155c positioned between the positive and negative electrode plates 155a and 155b to avoid a short circuit and enable only lithium ions to move. The positive and negative electrode plates 155a and 155b and the separator 155c interposed between them can be wound in an approximately jelly-roll shape and placed into the can 151. The positive electrode plate 155a can be made of aluminum (Al) foil, the negative electrode plate 155b can be made of copper (Cu) foil, and the separator 155c can be made of polyethylene (PE) or polypropylene (PE). However, the present invention is not limited to these materials. The positive and negative electrode plates 155a and 155b can have positive and negative electrode leads 156b and 156a respectively welded thereto, while protruding a predetermined length upwards. The positive and negative electrode leads 156b and 156a can be respectively made of aluminum (Al) and nickel (Ni). However, the present invention is not limited to these materials.

The can 151, as has already been described in detail, can include long-sided regions 151a positioned to face each other and having a predetermined area, short-sided regions 151b positioned between the long-sided regions 151a while facing each other and having an area less than that of the long-sided regions 151a, and a bottom-sided region 151c closing the long-sided regions 151a and the short-sided regions 151b. The opposite side of the can 151 to the bottom-sided region 151c is open.

In addition, an insulating case 157, a terminal plate 158, and an insulating plate 159 may be successively coupled to the top of the electrode assembly 155, particularly to the top of the can 151. The insulating case 157, the terminal plate 158, and the insulating plate 159 can have through-holes 157a, 158a, and 159a respectively formed thereon, so that the electrode terminal 154 can extend through to be coupled thereto from above.

The insulating case 157, the terminal plate 158, and the insulating plate 159 can be coupled to the top of the can 151. An approximately plate-shaped cap plate 152 is positioned on top of the insulating plate 159 and is welded to the edges of the long-sided regions 151a and the short-sided regions 151b. The cap plate 152 can have a through-hole 152a formed at the center thereof and an electrolyte injection hole 152b formed on a sided thereof for electrolyte injection. A ball 152c is welded to the electrolyte injection hole 152b after electrolyte injection. An insulating gasket 153 can be coupled to the through-hole 152a of the cap plate 152 and an electrode terminal 154 to the insulating gasket 153. The electrode terminal 154 can be welded to the negative electrode lead 156a and act as a negative electrode during charging or discharging. The positive electrode lead 156b mcan be directly welded to the cap plate 152 so that the can 151 and the cap plate 152 act as a positive electrode. Alternatively, the positive electrode lead 156b can be coupled to the electrode terminal 154 and act as a positive electrode and the negative electrode lead 156b can be welded to the cap plate 152 and act as a negative electrode.

The electrolyte (not shown) acts as a medium for movement of lithium ions created by an electrochemical reaction at the positive and negative electrodes inside the battery during charging/discharging and can be made of non-aqueous organic solution which is a mixture of lithium salt and a high-purity organic solvent. Alternatively, the electrolyte can be a polymer using a high-molecular electrolyte.

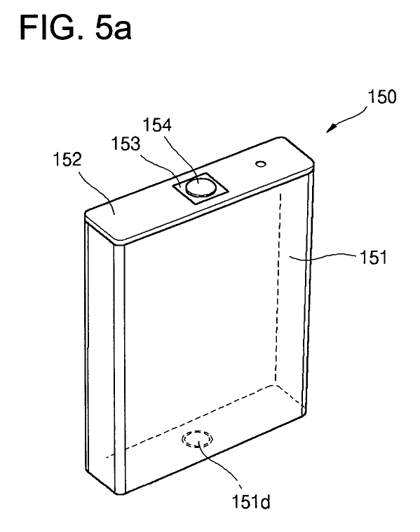

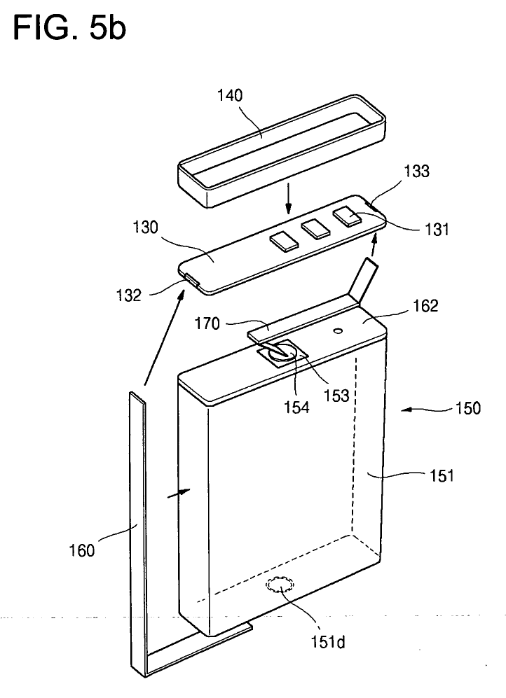

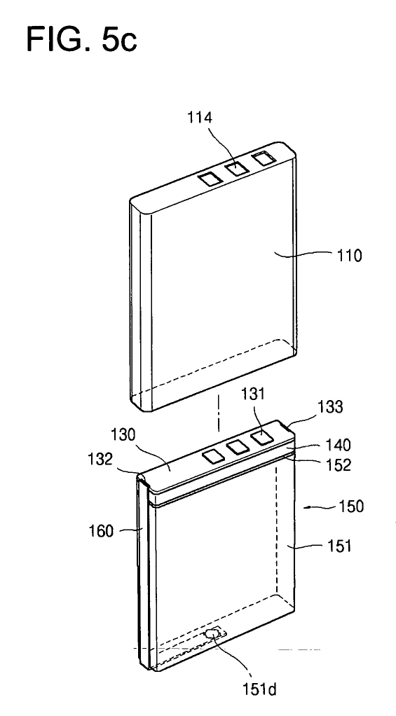

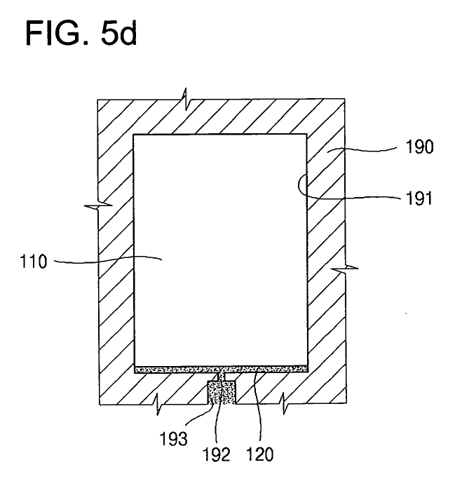

FIGS. 5a to 5d are views of a series of steps of a method of manufacturing a battery pack according to an embodiment of the present invention. As shown in FIG. 5a, a bare cell 150 is prepared which has no protective circuit module and the like mounted thereon. Particularly, a can 150 is prepared which has a safety vent 151d formed on a side of a can 151 and a cap plate 152 mounted on the other side thereof. The cap plate 152 has an electrode terminal 154 attached to the center thereof with an insulating gasket 153 interposed between them. The cap 151 and the cap plate 152 can act as the positive electrode of the bare cell 150 and the electrode terminal 154 can act as the negative electrode thereof, or vice versa.

As shown in FIG. 5b, a protective circuit module 130, a lead 160, a PTC thermistor 170, and an insulating ring 140 are attached to the bare cell 150. One side of the PTC thermistor 170 is welded to the electrode terminal 154 and the other side thereof is welded or soldered to a conductive pattern 133 of the protective circuit module 130. The insulating ring 140 is positioned between the protective circuit module 130 and the bare cell 150 to avoid any unnecessary short circuit between them. It is also possible to connect the PTC thermistor 170 after positioning the insulating ring 140, but the order of processes is not limited in the present invention. One side of the lead 160 is welded to the can 151 and the other side thereof is welded or soldered to a conductive pattern 132 of the protective circuit module 130. The lead 160 is positioned in such a manner that a side thereof overlaps the safety vent 151d formed on a side of the can 151. Particularly, the lead 160 is positioned on the surface of the safety vent 151d lest resin should pass through the safety vent 151d during resin filling process described later.

As shown in FIG. 5c, a case 110 is used to enclose the protective circuit module 130, the insulating ring 140, and the bare cell 150, which have been integrated into a single unit. The case 110 has at least one opening 114 formed on a side thereof to expose external terminals 131 formed on the protective circuit module 130 to the exterior. The protective circuit module 130, enclosed by the case 110, is attached to the bare cell 150 and does not detach from it. This means that no resin needs to fill the gap between the protective circuit module 130 and the bare cell 150. The lower portion of the bare cell 150 is exposed to the exterior via the case 110.

As shown in FIG. 5d, the case 110 containing the integral bare cell (not shown) is placed on a mold 190 having a predetermined shape. The mold 190 has a cavity 191 formed thereon, in which the case 110 is positioned. The length of the cavity 191 can be equal to or greater than that of the case 110, but the relative size is not limited in the present invention. The cavity 191 has a gate 192 and a runner 193 formed thereon. As a resin 120 of high temperature and pressure is injected through the runner 193, the resin 120 flows along the gate 192 and fills the interior of the case 110. The pressure or filling time of the resin 120 is properly controlled so that it reaches a level corresponding to about 50-90% of the overall height of the case 110. If the filling level of the resin 120 is less than 50% of the overall height of the case 110, then adhesiveness of the resin 120 to the case 110 and the bare cell 150 is poor, as mentioned above. If the filling level of the resin 120 is greater than 90% of the overall height of the case 110, then the high temperature (about 150° C.) of the resin 120 can be transmitted to the protective circuit module (not shown) and the PTC thermistor (not shown) mounted inside the case 110 and fracture them.

After these processes, the case 110 is removed from the mold 190. Then, a battery pack is completed which has external terminals (not shown) exposed via the openings (not shown) of the case 110 and which is filled with a resin 120 in the opposite direction.

As mentioned above, the battery pack and its method of manufacture according to embodiments of the present invention are advantageous in that, since the bare cell and the protective circuit module are enclosed by an integral case to fix them and a resin is used to fill only a part exposed via the case, the gap between the bare cell and the protective circuit module does not need to be filled with a resin. This reduces cost and prevents the protective circuit module and the PTC thermistor from being damaged.

Since a lead is positioned on the surface of the safety vent formed on the bare cell, the safety vent does not fracture during resin filling. Particularly, a resin of high temperature and pressure does not pass through the safety vent during the resin filling process, so that the safety vent is not fractured by it. As a result, the safety vent functions normally in the case of swelling and minimizes the danger of explosion.

Since a resin of high temperature and pressure is injected to the surface of the bare cell opposite to the protective circuit module, the resin's temperature is not transmitted to the protective circuit module or the PTC thermistor, which is positioned in the opposite direction. As a result, the protective circuit module or the PTC thermistor is protected from the resin of high temperature and pressure.

Although exemplary embodiments of the present invention have been described for illustrative purposes, those skilled in the art will appreciate that various modifications, additions and substitutions are possible, without departing from the scope and spirit of the invention as recited in the accompanying claims.

What is claimed is:

1. A battery pack comprising:
a bare cell;
a protective circuit module electrically connected to the bare cell;
a case integrally housing the bare cell and the protective circuit module and adapted to expose a predetermined region of the bare cell to the exterior; and
a resin adapted to fill a gap between the case and the bare cell and to cover a surface of the exposed predetermined region of the bare cell.

2. The battery pack as claimed in claim 1, further comprising a lead electrically connected between the bare cell and the protective circuit module.

3. The battery pack as claimed in claim 1, further comprising a PTC thermistor electrically connected between the bare cell and the protective circuit module.

4. The battery pack as claimed in claim 1, wherein the protective circuit module comprises at least one external terminal arranged thereon and wherein the case comprises an opening arranged therein, the opening corresponding to the at least one external terminal.

5. The battery pack as claimed in claim 1, further comprising an insulating ring arranged between the protective circuit module and the bare cell.

6. The battery pack as claimed in claim 1, wherein the resin extends to a level corresponding to 50-90% of an overall height of the case along the gap between the bare cell and the case.

7. The battery pack as claimed in claim 1, wherein the bare cell comprises a safety vent, arranged on the exposed predetermined region of the bare cell and having a thickness less than that of the bare cell, and a lead arranged on the safety vent and electrically connected to the protective circuit module.

8. A battery pack comprising:
a chargeable/dischargeable bare cell having positive and negative electrodes;
a protective circuit module arranged on a side of the bare cell;
a lead electrically connecting one of the positive and negative electrodes of the bare cell to the protective circuit module;
a PTC thermistor electrically connecting the other of the positive and negative electrodes of the bare cell to the protective circuit module;
a case integrally housing the bare cell, the protective circuit module, the lead, and the PTC thermistor and adapted to expose a side of the protective circuit module and a side of the bare cell to the exterior; and
a resin adapted to cover the exposed side of the bare cell.

9. The battery pack as claimed in claim 8, wherein the bare cell comprises:
a can having one of positive and negative polarities; and
an electrode terminal arranged on a side of the can and having a polarity different from that of the can.

10. The battery pack as claimed in claim 9, wherein the can comprises:
long-sided regions spaced apart from each other;
short-sided regions arranged on edges of the long-sided regions and spaced apart from each other; and
a bottom-sided region arranged on common edges of the long-sided regions and the short-sided regions.

11. The battery pack as claimed in claim 10, wherein the can further comprises a safety vent arranged in the bottom-sided region and having a thickness less than that of the can.

12. The battery pack as claimed in claim 11, wherein the safety vent comprises a lead arranged on a surface thereof.

13. The battery pack as claimed in claim 12, wherein the lead is welded to one of the bottom-sided region outside of the safety vent or to one of the short-sided regions.

14. The battery pack as claimed in claim 10, wherein the bottom-sided region of the can is exposed to the exterior of the case and is covered with a resin.

15. The battery pack as claimed in claim 10, wherein the resin fills a gap between the long-sided and short-sided regions of the can and the case and extends to a level corresponding to 50-90% of an overall height of the case from the bottom side.

16. The battery pack as claimed in claim 8, wherein the protective circuit module comprises at least one external terminal arranged thereon and wherein the case has an opening arranged therein, the opening corresponding to the external terminal.

17. The battery pack as claimed in claim 8, further comprising an insulating ring interposed between the bare cell and the protective circuit module.

18. The battery pack as claimed in claim 8, wherein the case comprises:
long-sided regions spaced apart from each other;
short-sided regions arranged on edges of the long-sided regions and spaced apart from each other; and
an upper-sided region arranged on common edges of the long-sided regions and the short-sided regions and having a number of openings.

19. The battery pack as claimed in claim 18, wherein the case has round portions arranged in the long-sided regions and the short-sided regions.

20. A method of manufacturing a battery pack, the method comprising:
preparing a chargeable/dischargeable bare cell;
electrically connecting a lead and a PTC thermistor to the bare cell and electrically connecting the lead and the PTC thermistor to a protective circuit module;
enclosing the protective circuit module and the bare cell in a case having an open side; and
covering an exposed side of the bare cell with a resin.

21. The method as claimed in claim 20, further comprising interposing an electrically insulating ring between the protective circuit module and the bare cell to prevent the protective circuit module from contacting and short-circuiting to the bare cell.

22. The method as claimed in claim 20, further comprising arranging a safety vent in the exposed side of the bare cell, the safety vent having a thickness less than that of the bare cell and a lead arranged on the safety vent while being connected to the protective circuit module to prevent resin from contacting the safety vent during a molding process.

23. The method as claimed in claim 20, further comprising extending the resin to a level corresponding to 50-90% of an overall height of the case along a gap between the bare cell and the case.
